(19) United States
(12) Patent Application Publication
(10) Pub. No.: US 2018/0048629 A1
(43) Pub. Date: Feb. 15, 2018

(54) Expression and Method to Send and Receive Text Messages Encrypted For The Targeted Receiving User to Render Eavesdropping Useless.

(71) Applicant: SAADELDIN (DEAN) EL-SEDFY, OAKVILLE (CA)

(72) Inventor: SAADELDIN (DEAN) EL-SEDFY, OAKVILLE (CA)

(73) Assignee: SAADELDIN (DEAN) EL-SEDFY, OAKVILLE (CA)

(21) Appl. No.: 15/236,433

(22) Filed: Aug. 13, 2016

(51) Int. Cl. H04L 29/06; H04W 12/06; H04W 12/04

(52) U.S. Cl. CPC H04L 63/0435; H04L 63/067; H04W 12/04; H04L 63/08; H04W 12/06

(57) ABSTRACT

The inventor owns the Copyrights to the work summarized hereinafter. The Copyright Certificate registration number is TX 7-579-575. The work was well detailed and submitted to the Copyright Office including the original version of the software code. The emphasis of this patent application is on the preferred METHOD[S], which cannot be Copyright Protected.

Disclosed here is an integrated computer system and its methods, in terms of sequence, structure and organization, which is an expression of the idea of mutual secured communications on the World Wide Web or Wireless Communications of text being transmitted between two end users. This particular system, and its methods, is a novel one that comprises of preferred encryption methods, algorithms, schemes and preferred novel structure of the TEXT or MESSAGE being electronically transmitted. The preferred method includes generating dynamically the personal keys and a public key required for the encryption scheme and algorithms. The keys inherit the ELECTRONIC DNA “eDNA” of the device, or computer, or the user, or a combination thereof (such as serial number, telephone number, birth date). The keys are not saved on a server or locally, but rather are added to the ciphered TEXT or MESSAGE being transmitted. The preferred encryption method is a novel one and not employing any known or published mathematical methods. The encryption process will automatically utilize a particular scheme, or process, depending on the value of the personal key of the user receiving the ciphered TEXT or Message. The decryption method is the opposite sense of the encryption method. Once the ciphered TEXT or MESSAGE has been received, the KEYS are extracted for verification purpose and identification of the decryption method to be used to decipher the TEXT or MESSAGE. Finally, the deciphered TEXT or MESSAGE is displayed employing the standard device's operating system or a special interface.

### BACKGROUND OF THE INVENTION

This invention relates to a computer implementation of an integrated system, which encompasses the structure, sequence and organization of a preferred method[s] and algorithm[s] to send and receive encrypted text or messages via the World Wide Web (www, i.e. internet), or wireless communications, by pro-grammatically invoking a special preferred encryption method, to be applied to the text, or message, being sent, according to the credentials or personal key, or eDNA, of the end user receiving the message. The invention also includes a preferred method and structure of the text or message being transmitted.

There are several methods of conveying a message or a text electronically whether through wired or wireless devices or computers. In those cases the encryption keys are kept somewhere on a common server, or embedded in the software as constant data. The aforementioned concept often leads the attacker to hack the server, or reverse engineer the software object module, to recover the keys and the encryption method.

In this invention the text or message is preferably encrypted specifically using the receiving user's credentials, in case of eavesdropping the interceptor will not be easily capable of deciphering the message utilizing the known techniques. Even in case the interceptor is lucky; only one message, at a time, would be compromised instead of compromising the entire scheme for all messages.

### BRIEF DESCRIPTION OF THE DRAWING

FIG. 1 Illustrates the preferred method of the integrated system, the preferred individual methods, the preferred sequence, structure and organization of the invention. Both of the preferred methods of sending and receiving the text or message are illustrated. They are invoked independently based on the end user's request.

FIG. 1 also illustrates the preferred initiation step of the application, which is typical for both sending and receiving methods.

### SUMMARY OF THE INVENTION

Disclosed hereinafter is a novel development of preferred integrated computer software system or method or process. The invention entails preferred sequence, structure and organization, preferred method[s] of encrypting and decrypting text, or messages, being transmitted via wired or wireless networks and also includes a preferred novel structure and method of the text or message being transmitted.

The preferred encrypting method[s] rely on preferred dynamically generated personal keys. The aforementioned keys are based on, an isolated value[s], or a combination thereof, of physical properties, of the computer object representing, the end users and the devices or machine or computer (e.g. telephone number, device's serial number, birth date, ASCII( ) value of the user's name, and other values). The keys, which are defined here as eDNAs, are the result of simple concatenations of the characters representing the physical values of the chosen property[ies].

The said preferred method[s] relies on a preferred theory by the inventor called Electronic DNA or eDNA. Briefly, the preferred eDNA theory adds to computer objects an auxiliary logically deduced, or specifically induced, property(ies] to provide the object with a unique identification scheme, or value. By examining the said eDNA; the specific characteristic[s] of the computer object can be determined. The eDNA can be a simple number or a very large string of characters.

Since the above mentioned eDNA is dynamically composed or created on the local machine or device and never stored on a server, the preferred method to structure the, transmitted decrypted or deciphered, text or message is to concatenate the deciphered text to the eDNA, or keys, and to transmit the preferred new structure of the text or message as one character string. This will allow the application running on the remote receiving device or computer to extract the body of the ciphered, or encrypted, message and the corresponding eDNA, or keys, to complete the verification and decryption processes on the receiving device or computer.

### DETAILED DESCRIPTION OF THE PREFERRED EMBODIMENTS

The method dynamically establishes a preferred unique computer object (eDNA) for each end user, by way of creating it, or composing it, or deducing it, from the contact list, or via dynamic input by the sending user. The preferred computer implemented method of this invention eliminates the necessity of storing the keys or the specific computer objects on servers, or being locally stored on the device or machine to avoid hacking the personal data or information. The aforementioned preferred method of dynamically composing the users' eDNA[s] is repeated every time the application is initiated (i.e. started).

For verification and security purpose; the said eDNA, or key, of the sending user must be verified. The preferred method is to verify the composed, or input, or created key against the contact list available on the sending device's, or computer as part of its operating system. Alternatively, an encrypted list will be created at the set up of the application containing the authorized users' credentials from which their respective eDNA[s] can be dynamically deduced. The preferred method is to dynamically deduce, or create, the eDNA and never store the final resulting values.

Very important elements of the preferred structure, sequence and organization of this invention are described below:
1. The inclusion of several preferred encryption schemes and methods, as well as the dynamic composition of the preferred personal keys and public key, based on their respective preferred eDNAs. Such dynamic flexibility will allow for almost infinite number of specific personal encryption schemes to cover a large number of users.
2. Although there are several other methods to achieve the same results; the preferred novel and unique method in this invention is that the encrypted text or message structure is modified to be added to the encrypted text or message. the newly preferred, composed or created, credentials of the receiving user and the preferred indicators as to which method was used for decrypting the text message. Briefly; this means that the transmitted text or message structure includes the message or text as well as the encryption keys.
3. The preferred encryption method originally developed in this invention is novel and does not rely on any old and known published schemes. The aforesaid preferred method comprises many preferred sub methods for encrypting the message or text being sent according to the credentials of the receiving user.
4. The starting preferred encryption sub method converts the user's input text or message to a string of individual characters. The aforementioned string will be re-constructed in a square matrix of characters. The latter will be transposed using up to nine different processes. The process of transposing, of the said matrix of characters, is dependent on the eDNA of the receiving user. The resulting new matrix of characters is then converted back to a string. At this stage the string is still composed of human readable characters, but the corresponding grammar and spelling of the original words, in whichever language, are now destroyed. Humans can still read the characters, but will not be able to make sense of them.
5. The character string described above in 4. may now be operated on by typical encryption schemes available in the public domain to produce the ciphered character set. The preferred encryption sub method developed in this invention will operate on each individual character in the string to shift the given character to a new position in the region of non human readable characters set of the ASCII table. The message now is ready to be transmitted, via wired device or wireless device, as encrypted string of characters non readable by humans.
6. To avoid having to store the eDNA or keys on a server, to prevent hacking, the preferred method in this invention is to change the structure of the ciphered string of the text or message by concatenating the used keys to the latter. The aforementioned preferred method will facilitate verification of the receiving user and enable the decryption of the ciphered text to be brought back to a human readable text or message.
7. The preferred decryption method is typically the opposite sequence of the above preferred methods. For example the first computer process is to loop through the inbox, or DB, to retrieve and define those messages with the structure that is compatible with the preferred text or message structure described above in 6. This will be followed by extracting the keys or eDNA[s] and the text body from the received text or message. Briefly, the preferred decryption method will follow the opposite sequence of the preferred methods described above in 6.,5.,4.&3. in that order.
8. Any failure during the decryption of the text or messages will lead the preferred integrated system of methods to ignore the message being processed and the looping will continue till the EOF( ) is reached.
9. The decrypted text or message will be passed on the man-machine interface for display. The man-machine interface can be one of those given by the operating system of the device or computer or can be specifically designed for a given application.

What is claimed is:

1. An integrated computer main method, in terms of structure, sequence and organization, which is an expression of the idea regarding encrypting and decrypting text messages being transmitted via wired or wireless devices or computers. The encryption method includes more than nine different sub-methods to allow for dynamic selection of the encryption sub-method to be used for a particular receiving end user. To perform the encryption or decryption; personal and public keys are dynamically deduced. The encryption keys are never stored locally or on a server. They are determined or deduced every time the computer application is initiated. The encryption keys are concatenated to the particularly encrypted, according to the receiving user, text message to form a new text message structure, before sending the integrated string. The sending operation is totally reliant on the device's or computer's operating system. At the receiving device or computer; the decryption method is the reverse of the aforementioned encryption method. The decryption method will start with selecting the appropriate text message whose structure is compatible with the novel text message structure of this invention. The second step of decryption is to extract the encryption keys from the text message body. The keys values will be compared to the receiving user's credentials to ensure no eavesdropping. The following steps of the decryption method are the reverse of the earlier discussed encryption method in the opposite order.

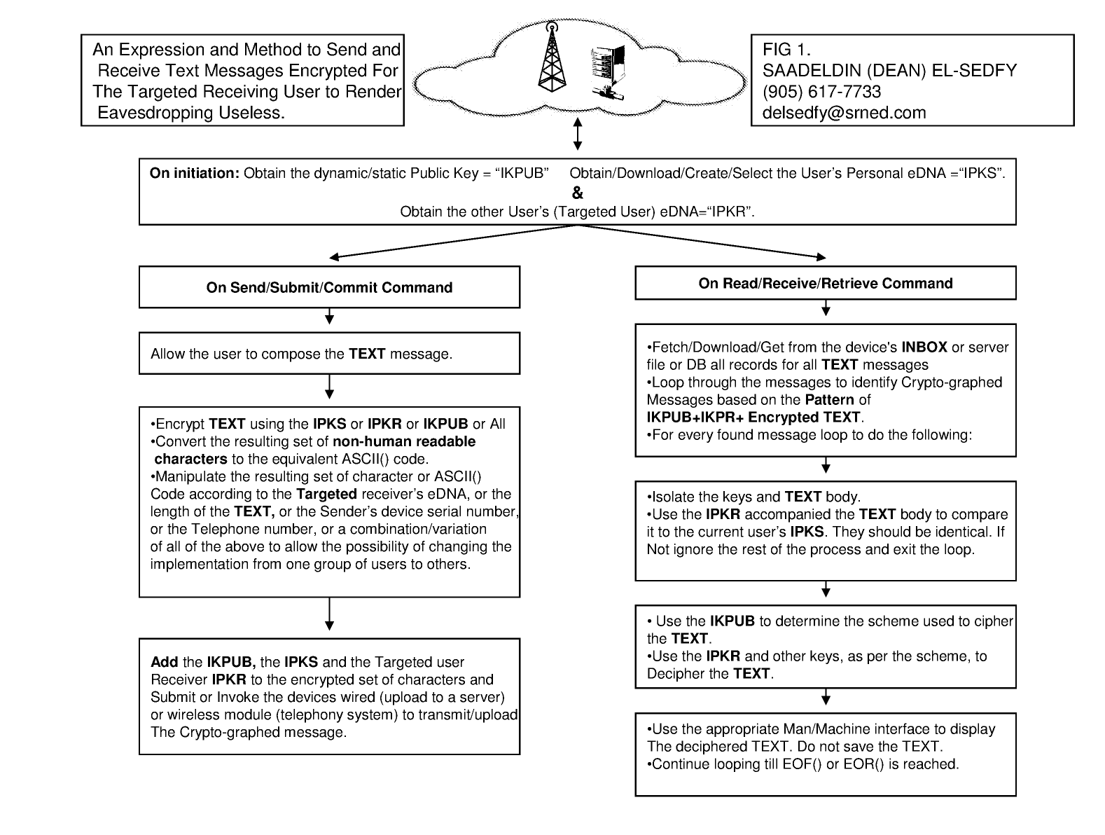

2. The method defined in 1 further comprising: of its preferred structure, sequence and organization as described herein and elsewhere in this invention application, in particular FIG. 1 and Copyright Certificate number: TX 7-579-575, of which the inventor is the owner of those Copyrights. The emphasis herein is on the METHOD, which cannot be protected under the Copyright Law and was never published anywhere else.

3. The method defined in 1 wherein: the encryption keys are deduced from the available physical or virtual properties of the computer objects representing the end users and the device or computer or a combination thereof; further the encryption keys are defined herein as eDNA, electronic DNA, as they contain and identify certain logical properties of the users and their respective devices.

4. The method defined in 1 wherein: the composition or creation of the encryption keys takes place at the sender's device or computer in isolation of the targeted receiver's device or computer and to avoid having to store the keys on a server; the encrypted text message body is preferably restructured in a way to include the dynamically deduced keys at the sender's device or computer.

5. The method defined in 1 wherein: the encryption method includes more than nine preferred sub-methods of restructuring the text body of the message into a square matrix of characters and transposing the matrix to destroy the grammar and spelling of the text message. The preferred transposition of the matrix will be performed according to a logical decision based on the deduced encryption key of the targeted receiving end user.
